(19) United States
(12) Patent Application Publication
(10) Pub. No.: US 2015/0109168 A1
(43) Pub. Date: Apr. 23, 2015

(54) MULTI-FREQUENCY ANTENNA AND MOBILE COMMUNICATION DEVICE HAVING THE MULTI-FREQUENCY ANTENNA

(71) Applicant: AUDEN TECHNO CORP., Taoyuan County (TW)

(72) Inventors: CHING-WEI CHANG, New Taipei City (TW); Yen-Chao Li, Taoyuan County (TW)

(73) Assignee: AUDEN TECHNO CORP., Taoyuan County (TW)

(21) Appl. No.: 14/058,226

(22) Filed: Oct. 19, 2013

(51) Int. Cl. H01Q 1/38; H01Q 9/04

(52) U.S. Cl. CPC H01Q 1/38; H01Q 9/04
USPC 343/700 MS

(57) ABSTRACT

The present disclosure provides a multi-frequency antenna for connecting to a circuit board of a mobile communication device. The circuit board has a grounding plane. The mobile communication device has a metal frame coupled to the grounding plane and surrounding the circuit board. The multi-frequency antenna comprises a first radiator and a second radiator. The first radiator is disposed adjacent to a lateral side of the grounding plane. The first radiator has a feeding end and a grounding end. The first radiator surrounds the metal frame adjacent to the lateral side of the grounding plane to forms a loop. The first radiator forms a first current path to provide a first operating mode. The second radiator connected to the first radiator forms a second current path to provide a second operating mode. The frequency of the second operating mode is higher than the frequency of the first operating mode.

### BACKGROUND OF THE INVENTION

1. Field of the Invention

The instant disclosure relates to an antenna; in particular, to a multi-frequency antenna and a mobile communication device having the multi-frequency antenna.

2. Description of Related Art

Existing mobile communication devices have been significantly improved in computing power and communication capabilities. Thus, in modern society, the mobile communication devices have been the carry-on articles of people for daily use. However, modem people also think highly of the external appearance of the mobile communication devices. Therefore, manufacturers for mobile communication devices present the appearance with many types of design concepts. In order to make mobile communication devices with novel appearance and excellent texture modeling, mobile communication devices would typically have metal chassis components. For example, metallic screen panel, back cover of the casing, or metal frame on the lateral side. However, for antenna design, the casing having a metal element would affect the antenna characteristics.

### SUMMARY OF THE INVENTION

The object of the instant disclosure is to offer a multi-frequency antenna and a mobile communication device having the multi-frequency antenna adapted for the mobile communication device having a metal frame. The multi-frequency antenna could meet the bandwidth requirements of Long Term Evolution (LTE) technology.

In order to achieve the aforementioned objects, according to an embodiment of the instant disclosure, a multi-frequency antenna is provided. The multi-frequency antenna is for connecting to a circuit board of a mobile communication device. The circuit board has a grounding plane. The mobile communication device has a metal frame coupled to the grounding plane and surrounding the circuit board. The multi-frequency antenna comprises a first radiator and at least a second radiator. The first radiator is disposed adjacent to a lateral side of the grounding plane, and has a feeding end and a grounding end. The first radiator surrounds the metal frame adjacent to the lateral side of the grounding plane to forms a loop. The first radiator forms a first current path to provide a first operating mode. The second radiator is connected to the first radiator to form a second current path for providing a second operating mode. The frequency of the second operating mode is higher than the frequency of the first operating mode.

In order to achieve the aforementioned objects, according to an embodiment of the instant disclosure, a mobile communication device is provided. The mobile communication device comprises a circuit board, a metal frame and a multi-frequency antenna. The circuit board has a grounding plane. The metal frame surrounds the circuit board and is coupled to the grounding plane of the circuit board. The multi-frequency antenna connecting to the circuit board comprises a first radiator and at least a second radiator. The first radiator is disposed adjacent to a lateral side of the grounding plane, and has a feeding end and a grounding end. The first radiator surrounds the metal frame adjacent to the lateral side of the grounding plane to form a loop. The first radiator forms a first current path to provide a first operating mode. The second radiator is connected to the first radiator to form a second current path for providing a second operating mode. The frequency of the second operating mode is higher than the frequency of the first operating mode.

In summary, the multi-frequency antenna and the mobile communication device having the multi-frequency antenna make the first radiator representing a loop antenna be disposed adjacent to the metal frame, so as to provide a parasitic capacitor. Thus, the bandwidth of the lower frequency operating mode (i.e. the first operating mode) could be increased, in which the bandwidth of the lower frequency operating mode affords the frequency ranges within 704 MHz-894 MHz and 880 MHz-960 MHz used in the LTE technology and the Global System for Mobile Communications (GSM) respectively.

In order to further the understanding regarding the instant disclosure, the following embodiments are provided along with illustrations to facilitate the disclosure of the instant disclosure.

### BRIEF DESCRIPTION OF THE DRAWINGS

FIG. 1A shows a schematic diagram of a mobile communication device having a multi-frequency antenna according to an embodiment of the instant disclosure;

FIG. 1B shows a schematic diagram of a multi-frequency antenna disposed in a mobile communication device according to an embodiment of the instant disclosure;

FIG. 2A shows a schematic diagram of a mobile communication device having a multi-frequency antenna according to another embodiment of the instant disclosure;

FIG. 2B shows a schematic diagram of a multi-frequency antenna disposed in a mobile communication device according to another embodiment of the instant disclosure;

FIG. 3 shows a schematic diagram of a mobile communication device having a multi-frequency antenna according to another embodiment of the instant disclosure;

FIG. 4 shows a schematic diagram of a multi-frequency antenna according to another embodiment of the instant disclosure; and

FIG. 5 shows a reflection coefficient (S11) measurement diagram of the multi-frequency antenna shown in FIG. 4.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

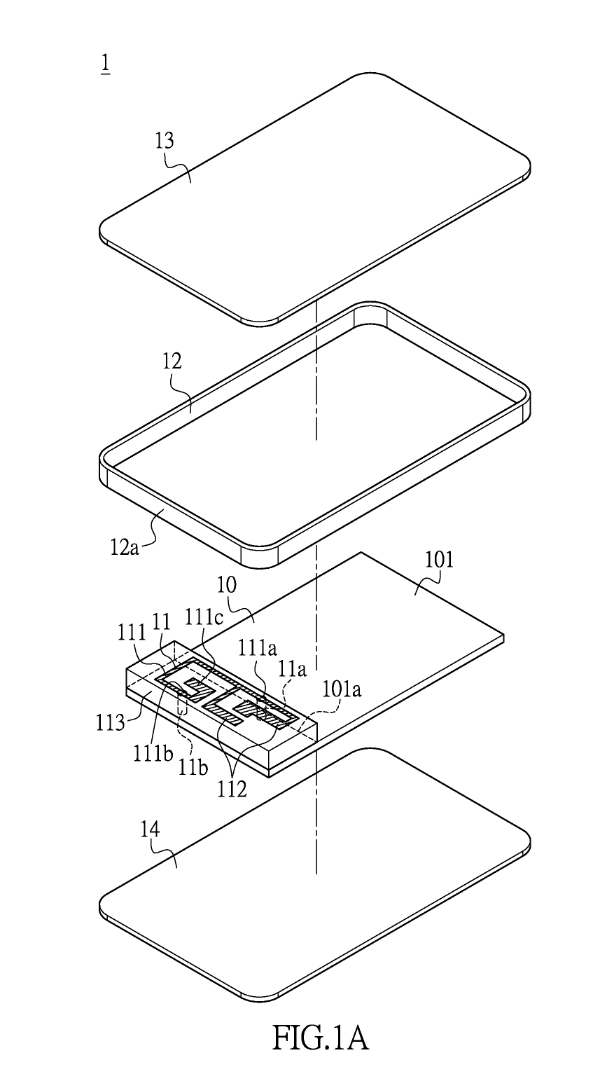

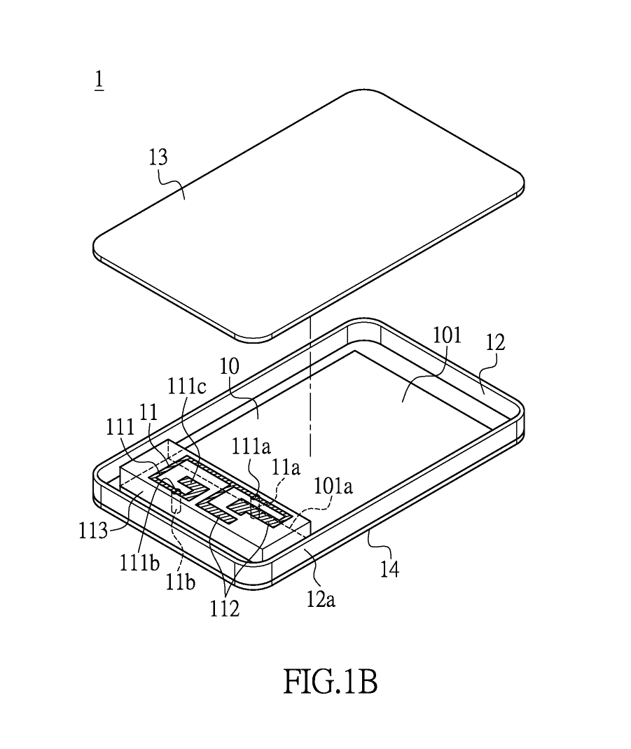

Please refer to FIG. 1A and FIG. 1B. FIG. 1A shows a schematic diagram of a mobile communication device having a multi-frequency antenna according to an embodiment of the instant disclosure. FIG. 1B shows a schematic diagram of a multi-frequency antenna disposed in a mobile communication device according to an embodiment of the instant disclosure. The mobile communication device 1 comprises a circuit board 10, a metal frame 12, a top cover 13, a bottom cover 14 and a multi-frequency antenna 11. The multi-frequency antenna 11 is connected to the circuit board 10. The metal frame 12, the top cover 13 and the bottom 14 are assembled to constitute the casing of the mobile communication device 1. In this embodiment, the multi-frequency antenna 11 is disposed on the circuit board of the mobile communication device 1, but the present invention is not so restricted. Other disposing positions of the multi-frequency antenna 11 are described in subsequent embodiments.

The circuit board 10 has a grounding plane 101. The metal frame 12 of the mobile communication device 1 is coupled to the grounding plane 101 and surrounds the circuit board 10 (i.e. surrounding the four lateral sides of the circuit board 10 shown in FIG. 1A). The multi-frequency antenna 11 comprises a first radiator 111, a feeding element 11a, a grounding element lib, at least a second radiator 112 and a base 113. The base 113 supports the first radiator 111 and the second radiator 112. The first radiator 111 is disposed adjacent to a lateral side 101a of the grounding plane 101. The first radiator 111 has a feeding end 111a, an extension portion 111c and a grounding end 111b. In one embodiment, the extension portion 111c could be omitted. The extension portion 111c is connected to the grounding end 111b and is adjacent to the grounding element 11b for adjusting the bandwidth of the first operating mode generated by the first radiator 111.

As shown in FIG. 1B, the first radiator 111 surrounds the metal frame 12 adjacent to the lateral side 101a of the grounding plane 101 to forms a loop. In means the loop formed by the first radiator 111 is adjacent to the lateral side 12a of the metal frame 12, and the lateral side 12a represents one of the lateral sides of the casing of the mobile communication device 1. The first radiator 111 forms the loop antenna and the length of the first radiator 111 is about to one wave-length of the corresponding operating frequency.

Generally, the multi-frequency antenna 11 could be installed to the bar-type mobile communication device 1 (for example, a cell phone) and is adjacent to a short edge of the bar-type mobile communication device 1. The loop formed by the first radiator 11 and the adjacent metal frame 12 provide a parasitic capacitance to increase the bandwidth of the lower frequency. In this embodiment, the metal frame 12 of the mobile communication device 1 is used to achieve the purpose of increasing the bandwidth of the antenna. The mentioned metal frame 12 may be made of stainless steel, aluminum, or alloy, for example.

Please refer to FIG. 1A and FIG. 1B again. The feeding element 11a is disposed on the circuit board 10 for feeding a radio frequency signal. The feeding element 11a is connected to the feeding end 111a of the first radiator 111. The grounding element 11b is disposed on the circuit board 10 and extends outward from the lateral side 101a of the grounding plane 101 for connecting the grounding end 111b of the first radiator 111. It is worth mentioning that when the lengths of the feeding element 11a and the grounding element 11b cannot be ignored, the total length of the feeding element 11a, the first radiator 111 and the grounding element 11b is about to one wave-length of the corresponding operating frequency.

The first radiator 111 forms a first current path to provide a first operating mode. The second radiator 112 is connected to the first radiator 111 to form a second current path for providing a second operating mode. The frequency of the second operating mode is higher than the frequency of the first operating mode. The second radiator 112 could be connected to the feeding end 111a of the first radiator 111, for example. Or, the second radiator 112 could be connected to any position of the loop structure formed by the first radiator 111. An artisan of ordinary skill in the art can design the position of the second radiator 112 arbitrarily as needed.

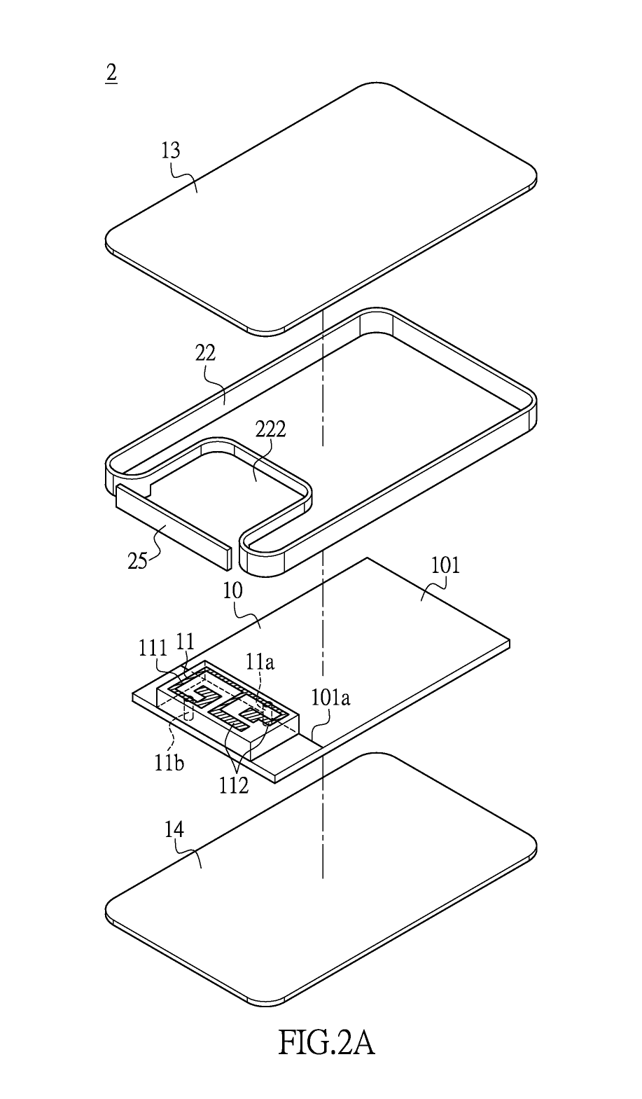

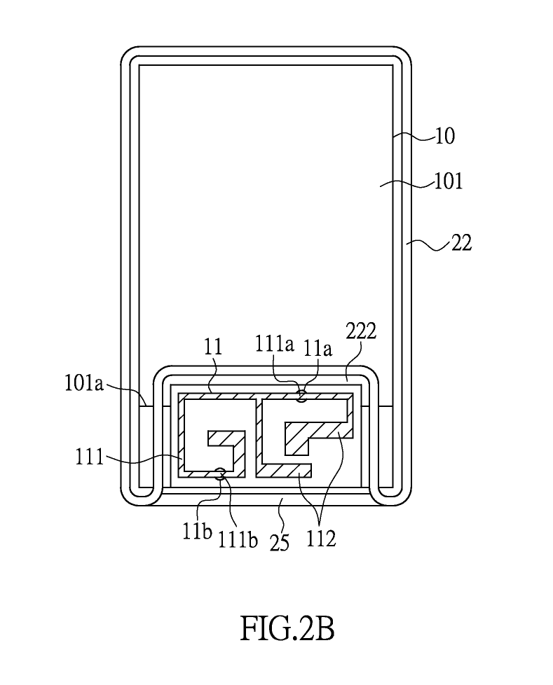

Please refer to FIG. 1A in conjunction with FIG. 2A and FIG. 2B. FIG. 2A shows a schematic diagram of a mobile communication device having a multi-frequency antenna according to another embodiment of the instant disclosure. FIG. 2B shows a schematic diagram of a multi-frequency antenna disposed in a mobile communication device according to another embodiment of the instant disclosure. The mobile communication device 2 comprises a circuit board 10, a metal frame 22, a lateral side cover 25, a top cover 13, a bottom cover 14 and a multi-frequency antenna 11. The multi-frequency antenna 11 is connected to the circuit board 10. The metal frame 22, the lateral side cover 25, the top cover 13 and the bottom cover 14 are assembled to constitute the casing of the mobile communication device 2. The multi-frequency antenna 11 comprises a first radiator 111, a feeding element 11a, a grounding element 11b and at least a second radiator 112.

In this embodiment, the mobile communication device 2 is significantly identical to the mobile communication device 1 shown in FIG. 1A except for differences specified in the follows. The structure of the metal frame 22 of the mobile communication device 2 is different from the metal frame 12 shown in FIG. 1A. In order to make the bandwidth of the antenna achieve the requirement of the LTE technology, especially for the frequency band of 704 MHz-894 MHz used in the LTE technology, the metal frame 12 shown in FIG. 1A is bent inwardly and extended to across the lateral side 101a of the grounding plane 101 so as to make the metal frame 22. As shown in FIG. 2B, the metal frame 22 crosses the lateral side 101a and a part of the metal frame 22 overlaps the grounding plane 101 (looking from the top-view angle). In other words, the path of the metal frame 22 adjacent to the lateral side 101a of the grounding plane 101 is repeatedly bended to form a concave region 222, and the first radiator 111 surrounds the rim of the concave region 222 to form the loop. The concave region 222 is above the grounding plane 101 and a part of the concave region 222 overlaps the grounding plane 101 (looking from the top-view angle). It is worth mentioning that the lateral side cover 25 may not comprise metal in order to increase the bandwidth of the antenna.

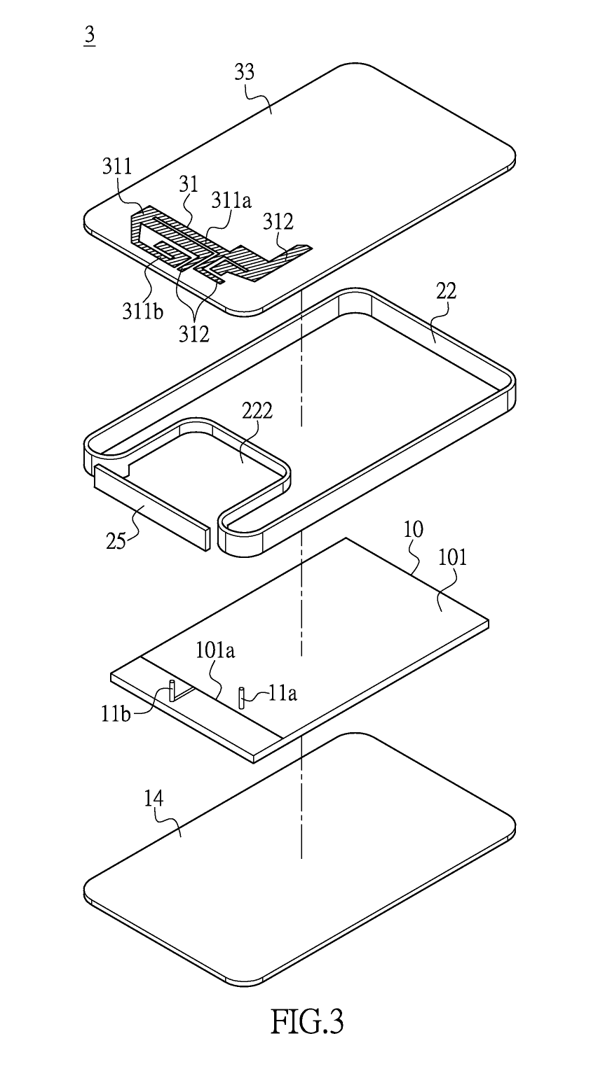

FIG. 3 shows a schematic diagram of a mobile communication device having a multi-frequency antenna according to another embodiment of the instant disclosure. The mobile communication device 3 comprises a circuit board 10, a metal frame 22, a top cover 33, a bottom cover 14 and a multi-frequency antenna 31. The multi-frequency antenna 31 is connected to the circuit board 10 through a feeding element 11a and a grounding element 11b. The metal frame 22, the top cover 33 and the bottom cover 14 is assembled to constitute the casing of the mobile communication device 3. In this embodiment, the multi-frequency antenna 31 does not need the base 113 which is disclosed in previous embodiments for supporting. The multi-frequency antenna 31 is disposed on the top cover 33, but the present invention is not so restricted. The multi-frequency antenna 31 may be disposed on the outward side or the inward side of the top cover 33, in which the outward side corresponds to the out surface of the casing, and the inward side corresponds to the inner side of the casing. The multi-frequency antenna 31 may be realized by utilizing a metal plate which is fixed onto the top cover 33. The multi-frequency antenna 31 may also be made by the laser direct structuring technology.

The circuit board 10 has a grounding plane 101. The metal frame 22 of the mobile communication device 3 is coupled to the grounding plane 101 and surrounds the circuit board 10. The multi-frequency antenna 31 comprises a first radiator 311, a feeding element 11a, a grounding element 11b and at least a second radiator 312. The first radiator 311 is disposed adjacent to a lateral side 101a of the grounding plane 101. The first radiator 311 has a feeding end 311a and a grounding end 311b. As shown in FIG. 3, the first radiator 311 surrounds the metal frame 22 adjacent to the lateral side 101a of the grounding plane 101 to form a loop. In means the path of the metal frame 22 adjacent to the lateral side 101a of the grounding plane 101 is repeatedly bended to form a concave region 222, and the first radiator 311 surrounds the rim of the concave region 222 to form the loop. The concave region 222 is above the grounding plane 101 and a part of the concave region 222 overlaps the grounding plane 101 (looking from the top-view angle).

Please refer to FIG. 3 again. The feeding element 11a is disposed on the circuit board 10 for feeding a radio frequency signal. The feeding element 11a is connected to the feeding end 311a of the first radiator 311. The grounding element 11b is disposed on the circuit board 10 and extends outward from the lateral side 101a of the grounding plane 101 for connecting the grounding end 311b of the first radiator 311. The first radiator 311 forms a first current path to provide a first operating mode. The second radiator 312 is connected to the first radiator 311 to form a second current path for providing a second operating mode. The frequency of the second operating mode is higher than the frequency of the first operating mode. The second radiator 312 could be connected to the feeding end 311a of the first radiator 311, for example. Or, the second radiator 312 could be connected to any position of the loop structure formed by the first radiator 311. An artisan of ordinary skill in the art can design the position of the second radiator 312 arbitrarily as needed.

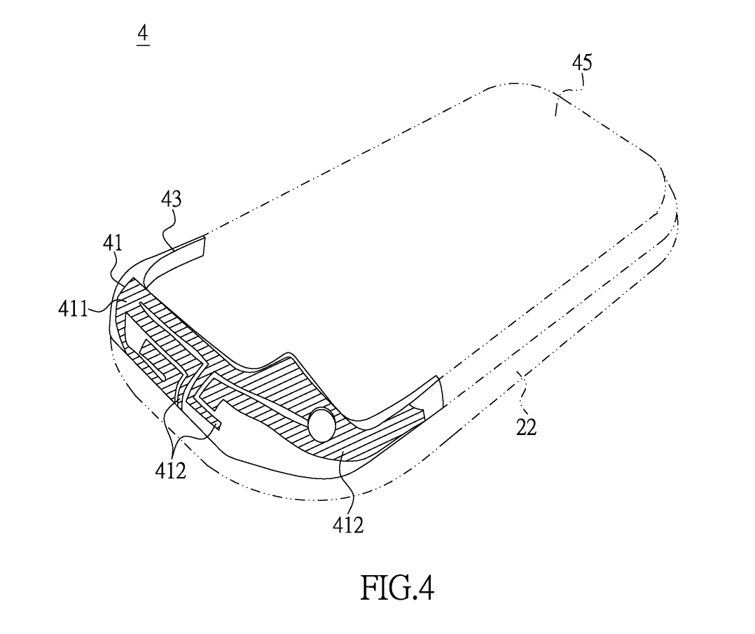

Please refer to FIG. 3 in conjunction with FIG. 4, FIG. 4 shows a schematic diagram of a multi-frequency antenna according to another embodiment of the instant disclosure. The multi-frequency antenna 41 shown in FIG. 4 is significantly identical to the multi-frequency antenna 31 shown in FIG. 3 except for differences specified in the follows. The multi-frequency antenna 31 shown in FIG. 3 is disposed on the planar top cover 33. On the contrary, the multi-frequency antenna 41 shown in FIG. 4 is disposed on the top cover 43 which has a curved surface. The top cover 43 and the top cover 45 compose a complete top cover of the mobile communication device 4. The multi-frequency antenna 41 comprises a first radiator 411, a feeding element 11a (shown in FIG. 3), a grounding element 11b (shown in FIG. 3) and at least a second radiator 412.

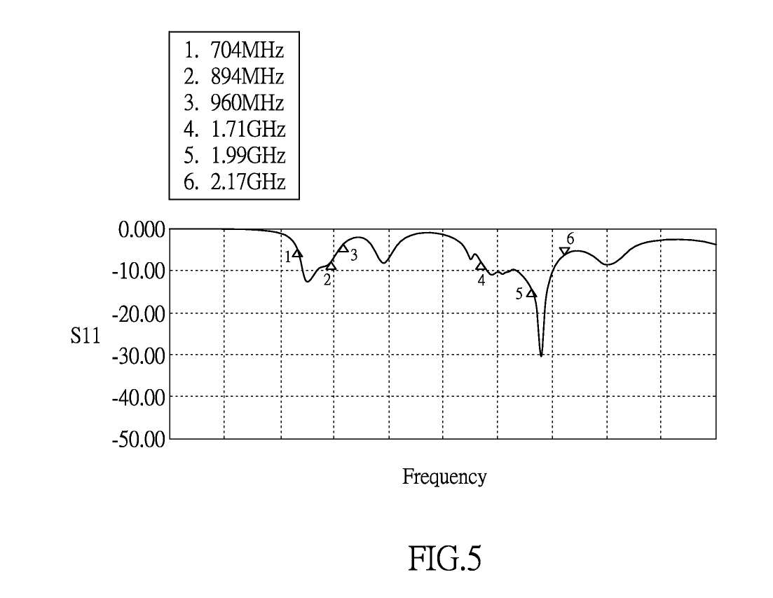

Please refer to FIG. 4 in conjunction with FIG. 5, FIG. 5 shows a reflection coefficient (S11) measurement diagram of the multi-frequency antenna shown in FIG. 4. The first radiator 412 forming a loop antenna generates the first operating mode, and the bandwidth refers to the frequency range within 704 MHz-960 MHz. A plurality of second radiators 412 (three second radiators 412 are shown in FIG. 4) generate the second operating mode, and the bandwidth refers to the frequency range within 1710 MHz-2170 MHz.

According to above descriptions, the multi-frequency antenna and the mobile communication device having the multi-frequency antenna make the first radiator representing a loop antenna be disposed adjacent to the metal frame or adjacent to the concave region of the metal frame, so as to provide a parasitic capacitor. Thus, the bandwidth of the lower frequency operating mode could be increased, in which the bandwidth of the lower frequency operating mode affords the frequency ranges within 704 MHz-894 MHz and 880 MHz-960 MHz used in the LTE technology and the Global System for Mobile Communications (GSM) respectively. Additionally, the second radiator generates the second operating mode to afford the bandwidth within 1710 MHz-2170 MHz, which meets the requirement of multi-frequency operation for the modern wireless communication device.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A multi-frequency antenna for connecting to a circuit board of a mobile communication device, the circuit board having a grounding plane, the mobile communication device having a metal frame coupled to the grounding plane and surrounding the circuit board, the multi-frequency antenna comprising:
a first radiator, disposed adjacent to a lateral side of the grounding plane, having a feeding end and a grounding end, wherein the first radiator surrounds the metal frame adjacent to the lateral side of the grounding plane to form a loop, the first radiator forms a first current path to provide a first operating mode; and
at least a second radiator, connected to the first radiator to form a second current path for providing a second operating mode, wherein the frequency of the second operating mode is higher than the frequency of the first operating mode.

2. The multi-frequency antenna according to claim 1, further comprising:
a feeding element, disposed on the circuit board for feeding a radio frequency signal, wherein the feeding element is connected to the feeding end of the first radiator; and
a grounding element, disposed on the circuit board, extending outward from the lateral side of the grounding plane for connecting the grounding end of the first radiator.

3. The multi-frequency antenna according to claim 1, wherein the path of the metal frame adjacent to the lateral side of the grounding plane is repeatedly bended to form a concave region, the first radiator surrounds the rim of the concave region to form the loop.

4. The multi-frequency antenna according to claim 3, wherein a part of the concave region is above the grounding plane, thus the projection of the part of the concave region on the circuit board overlaps with the grounding plane.

5. The multi-frequency antenna according to claim 1, further comprising:
a base, supporting the first radiator and the second radiator.

6. A mobile communication device, comprising:
a circuit board, having a grounding plane;
a metal frame, surrounding the circuit board, coupled to the grounding plane of the circuit board; and
a multi-frequency antenna, connecting to the circuit board, comprising:
a first radiator, disposed adjacent to a lateral side of the grounding plane, having a feeding end and a grounding end, wherein the first radiator surrounds the metal frame adjacent to the lateral side of the grounding plane to form a loop, the first radiator forms a first current path to provide a first operating mode; and
at least a second radiator, connected to the first radiator to form a second current path for providing a second operating mode, wherein the frequency of the second operating mode is higher than the frequency of the first operating mode.

7. The mobile communication device according to claim 6, further comprising:
a feeding element, disposed on the circuit board for feeding a radio frequency signal, wherein the feeding element is connected to the feeding end of the first radiator; and
a grounding element, disposed on the circuit board, extending outward from the lateral side of the grounding plane for connecting the grounding end of the first radiator.

8. The mobile communication device according to claim 6, wherein the path of the metal frame adjacent to the lateral side of the grounding plane is repeatedly bended to form a concave region, the first radiator surrounds the rim of the concave region to form the loop.

9. The mobile communication device according to claim 8, wherein a part of the concave region is above the grounding plane, thus the projection of the part of the concave region on the circuit board overlaps with the grounding plane.

10. The mobile communication device according to claim 6, further comprising:
a base, supporting the first radiator and the second radiator.
